(19) United States
(12) Patent Application Publication
(10) Pub. No.: US 2014/0128027 A1
(43) Pub. Date: May 8, 2014

(54) WIRELESS DATA CARD

(71) Applicant: ALCATEL LUCENT, Paris (FR)

(72) Inventor: Ranjan Ghosh, Mahadevapura (IN)

(73) Assignee: ALCATEL LUCENT, Paris (FR)

(21) Appl. No.: 14/122,007

(22) PCT Filed: May 2, 2012
(86) PCT No.: PCT/EP2012/057975

§ 371 Date: Nov. 25, 2013

(30) Foreign Application Priority Data
Jun. 7, 2011 (IN) 1611/DEL/2011

(51) Int. Cl. H04L 12/14; H04W 4/26

(52) U.S. Cl. CPC H04L 12/141; H04W 4/26; H04L 12/1403
USPC 455/407; 455/405

(57) ABSTRACT

According to one embodiment, the method determines a total amount of data exchanged between the wireless data card and a service provider for a time period. The determined total amount of data exchanged is further displayed on the display of the wireless data card. In one embodiment, the size of at least one data packet sent by the wireless data card and the size of at least one data packet received by the wireless data card within the time period is ascertained to determine the total amount of data exchanged.

### FIELD OF INVENTION

The present subject matter relates to display of information and, particularly but not exclusively, to display of information on a wireless data card.

### BACKGROUND

Typically, a communication network includes a medium to provide a communication link between various computing devices, such as computers, laptops, and PDAs, connected to that network. Generally, this medium includes a series of interlinked resources such as routers, switches, and physical wires to provide the communication link between different computing devices connected to the communication network. To facilitate exchange of data between the computing devices, multiple protocols such as Transmission Control Protocol/Internet Protocol (TCP/IP), User Datagram Protocol (UDP), Datagram Congestion Control Protocol (DCCP), and the like, are implemented in the communication network. These protocols may be used on the Internet, intranet, a local area network (LAN), or a wide area network (WAN).

Such multiple protocols can be implemented in wired as well as wireless networks. The availability of wireless network connections is becoming more and more common, allowing for the reach of networks in many locations in which running wires were previously inconvenient or prohibitively expensive. In a wireless network communications link, radio signals are used to broadcast information across different computing systems and service providers. Thus, the elimination of physical wires for connecting to the communication network has made networking easy and convenient. However, to exchange information wirelessly, a wireless transceiver is required. A wireless transceiver may transmit and receive information wirelessly to provide connectivity with the wireless network. For example, for a laptop to exchange information over a wireless network, a wireless network card would be required.

With the advent of wireless broadband technology such as Evolution-Data Optimized or Evolution-Data Only (EV-DO) in Code Division Multiple Access (CDMA), and High-Speed Downlink Packet Access (HSDPA) in Global System for Mobile (GSM) Communications, high speed Internet is made available to user mobile devices such as, smartphones, mobile phones, laptops, and the like by several different service providers, generally, by means of a wireless network transceiver hardware, such as a wireless broadband data card.

### SUMMARY

This summary is provided to introduce concepts related to display of data exchange information on a wireless data card in a communication network. This summary is not intended to identify essential features of the claimed subject matter nor is it intended for use in determining or limiting the scope of the claimed subject matter.

In accordance with one embodiment of the present subject matter, a wireless data card configured to display information on a display of the wireless data card is described. In said embodiment, the wireless data card is configured to determine a total amount of data exchanged between the wireless data card and a service provider for a pre-determined time period. The wireless data card is further configured to display the determined total amount of data exchanged on the display of the wireless data card. In one embodiment, a size of at least one data packet sent by the wireless data card and a size of at least one data packet received by the wireless data card within the pre-determined time period is ascertained to determine the total amount of data exchanged.

In accordance with another embodiment of the present subject matter, a display system to display information on a display of a wireless data card is described. According to one embodiment, the display system is configured to determine a total amount of data exchanged between the wireless data card and a service provider for a pre-determined time period. The display system is further configured to display the determined total amount of data exchanged on a display of the wireless data card.

Embodiments of a method for displaying information associated with a wireless data card are described. In one embodiment, the method comprises determining a total amount of data exchanged between the wireless data card and a service provider for a pre-determined time period and further displaying the total amount of data exchanged on a display of the wireless data card. In another embodiment of the present subject matter, the method comprises receiving a data plan associated with the wireless data card and evaluating billing information for the wireless data card based on the total amount of data exchanged and the data plan. In said embodiment, the billing information is displayed on the display of the wireless data card.

In accordance with yet another embodiment of the present subject matter, a computer readable medium having a set of computer readable instructions is disclosed. The computer readable instructions on the computer readable medium, when executed, perform acts including determining a total amount of data exchanged between a wireless data card and a service provider. The acts may also include identifying a data plan associated with the wireless data card and evaluating billing information for the wireless data card based on the total amount of data exchanged and the data plan. Further, the acts may include displaying the billing information on a display of the wireless data card.

### BRIEF DESCRIPTION OF THE FIGURES

The detailed description is described with reference to the accompanying figures.

In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 schematically illustrates a networking environment utilizing a wireless data card and a display system, in accordance with an embodiment of the present subject matter;

FIG. 2 illustrates a wireless data card for displaying information on a display of the wireless data card, in accordance with an embodiment of the present subject matter.

FIG. 3 illustrates a method for displaying information, for example, of data exchange between the wireless data card and the service provider, in accordance with an embodiment of the present subject matter.

FIG. 4 illustrates a method for displaying billing information for a user on a display of a wireless data card, in accordance with an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

The present subject matter relates to methods and systems for displaying information on a wireless data card. Typically, a wireless data card is a transceiver which allows wireless access to a communication network to enable communication between a computing device and the communication network. To provide high speed data transfer between the communication network and the computing device, wireless data card devices generally exchange data with a service provider based on various radio communication technologies, for example, Evolution-Data Optimized or Evolution-Data Only (EV-DO) technology in Code Division Multiple Access (CDMA), High-Speed Downlink Packet Access (HSDPA) technology in Global System for Mobile Communications (GSM), and the like. Service providers issue such wireless data cards providing high speed data transfers between computing devices, such as smartphones, desktops, and laptops used by users and the communication network.

Typically, for providing high speed data transfer through the wireless data cards, the service providers offer different data plans to the users. Such data plans are generally provided to the user to charge them according to their data usage. Moreover, such data plans, for example, may limit the amount of data that can be exchanged in a pre-defined time between the wireless data card and the service provider. Different data plans allow a user to choose from different data transfer limits for the pre-determined time. The data plans may also indicate the amount charged by the service provider to a user for data transfer during the pre-determined time interval. Further, tariffs for data exchange beyond the data transfer limit may also be provided in the data plan and may vary from one plan to the other.

For example, a user accessing the Internet by utilizing a wireless data card working on HSDPA technology may choose a data plan that allows n Giga Byte (GB) limit of data transfer between the wireless data card and the service provider at a fixed charge of p monitory units for the pre-determined time interval of one month. Also, the data plan may specify a tariff of x monetary units per m Kilo bit (Kb) of data that is exchanged over and above the specified limit of n GB data. The data plan may further specify particular periods such as from 00:00 hours to 06:00 hours as special or happy hours, during which the rate of data transfer may be greater than or less than p Kb/sec. Therefore, for each user to access the Internet through the wireless data card, a data plan having a pre-defined billing structure is associated which determines the data transfer limit for the user.

Typically, during the pre-defined time interval when the wireless data card provides connection between the computing device and the service provider, to identify the amount of data exchanged, the user has to either request the same through an application running on the computing device, or should login onto a web portal which is typically hosted by the service provider, with a unique user identification (ID) and a password. In other words, the user has to switch-on the computing system and look at the software or a web portal provided by the wireless data card provider to identify the amount of data exchanged.

Further, in some situations, the information can be collected through service provider officials, such as customer executive assistants. Furthermore, in certain situations, the information made available to the user is not a real time update and only the usage up to previous day or few hours before the current time is made available. To identify other information, like billed amount and due payments, a user may have to undergo a similar process of requesting such information from an application or a web portal. Hence, in situations mentioned above, for the user to identify information related to the wireless data card, such as an amount of data exchanged and billed amount, specific actions are to be taken. Many such actions might be time consuming and inconvenient due to tedious steps involved and might be inefficient due to non-availability of real time updated data. Therefore, it would be advantageous to have an improved method and apparatus for identifying the data usage of a wireless data card for a user, which may provide accurate information more conveniently.

According to an implementation of the present subject matter, systems and methods for displaying information on a wireless data card are described. The wireless data card as described herein is configured to, on one hand, display data exchange information and, on the other, provide billing information of the user based on the data exchanged. In said implementation, the data-exchange information may include the amount of data received from the service provider and the amount of data sent to the service provider. The system can be implemented in a variety of wireless data cards. The wireless data cards that implement the described method(s) include, but are not limited to, data cards external to a computing system, data cards internal to a computing system, data cards utilizing EV-DO technology, data cards utilizing HSDPA technology. Additionally, the wireless data card may support different internet protocols which may include, but are not limited to, Internet Protocol Version 4 (IPv4), Internet Protocol Version 6 (IPv6), Internet Control Message Protocol (ICMP), Internet Control Message Protocol Version 6 (ICMPv6), and Internet Group Management Protocol (IGMP).

In order to display data exchange information and the billing information, in one implementation, a record of data packets transmitted and received by the wireless data card is kept. In said implementation, size of the transmitted and received data packets may be determined and stored. Based on the size of each data packet and the number of data packets exchanged, a total amount of data exchanged between the wireless data card and the service provider is computed.

For example, a wireless data card may generate three data packets of 0.5 MB each and receive five data packets out of which two are of 0.5 MB each and three packets are of 1 MB each. In such a scenario, the record of all the eight packets exchanged between the wireless data card and the service provider is maintained, and the total amount of data exchange of 5.5 MB is computed.

In said implementation, the total amount of data exchanged between the wireless data card and the service provider is displayed on a display of the wireless data card. The display panel may be integrated with the wireless data card. In another implementation, the amount of data received and the amount of data sent is displayed separately. It will be understood that the total amount of data exchanged between the wireless data card and the service provider depends on the data received and the data sent by the wireless data card and, therefore, representation of either the total amount of data exchanged or the received and sent data depicts data usage by a user. Further, it would also be appreciated that the data exchange information may be provided to the user in a variety of ways based on the preferences of a user.

In one implementation, the information displayed on the display of the wireless data card may dynamically change depending on the amount of data exchanged between the wireless data card and the service provider. The data packets sent and received may be counted and the data usage information may be updated in real time on the display of the wireless data card to provide the latest available information to the user.

In one implementation, the computation of data exchange information is with respect to a pre-determined time period. The computation of the information may be on a cyclic/periodic basis and a cycle may be determined based on the data plan of the user. In other words, the total amount of data exchanged is recorded from a pre-determined time, and the data packets sent and received after the pre-determined time are utilized to evaluate the total amount of data exchanged on a cyclic basis.

In one implementation, the pre-determined time may be based on the data plan of the wireless data card. For example, if in the data plan taken by the user, the data usage limit is refreshed after every month, the pre-determined time may be set to one month where the data exchanged for the month is recorded, displayed, and the total data exchanged for the month is evaluated. To evaluate the data exchanged in the next month, the data exchanged during the previous month may be discounted and not accounted for. Similarly, if the pre-determined time is set for two months or a quarter of a year, the system may keep record of the data exchanged between the wireless data card and the service provider for the two months or the quarter and start a fresh recording thereafter. Although the pre-determined time period is explained to be based on the data plan, however a user may also define the time period for which the display of the total data usage is desired.

Moreover, a user may also be allowed to view the data-exchange history. The data exchange information of previous time periods may be stored and displayed based on the user request. For example, for a pre-determined time of one month, the amount of data exchanged during the month of, say, September, may be recorded and displayed. Similarly, for the amount of data exchanged during the month of October, the data exchanged during the month of October is maintained and displayed. Further, the amount of data exchanged during September may also be displayed in the month of October, upon identifying a user request for the same.

According to one implementation of the present subject matter, billing information related to the user may also be evaluated. In one embodiment of the subject matter, service provider may be communicated to identify the tariff to be levied on the user and the billing information may then be evaluated and displayed on the wireless data card. In another embodiment, the tariff may be entered by the user. Based on the details provided by the user, the billing information may then be evaluated. It would also be understood by those skilled in the art that the tariff on the exchange of data is defined by the data plan for the wireless data card and may vary for different data plans and different users.

Although it has been explained that the total amount of data exchanged is recorder and the billing information is evaluated, however, in one implementation, the billing details and the total amount of data exchanged by the wireless data card may be requested directly from the service provider and displayed on the wireless data card.

It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

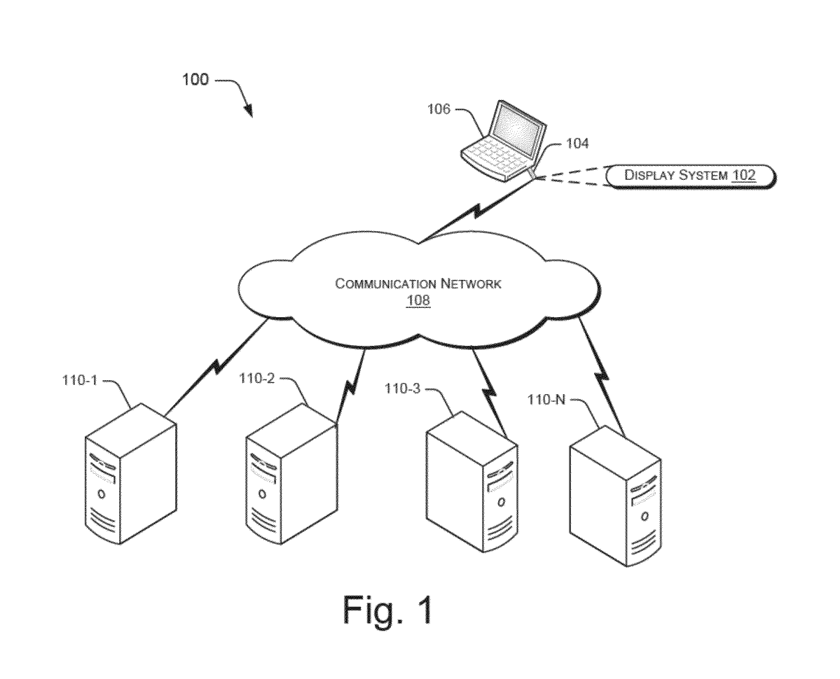

The manner in which the systems and methods for display of information on a display of a wireless data card are implemented shall be explained in details with respect to the FIGS. 1-4. While aspects of described systems and methods for displaying information on a display of the wireless data card can be implemented in any number of different wireless network devices, environments, and/or configurations, the embodiments are described in the context of the following exemplary system(s).

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

FIG. 1 illustrates a wireless networking environment 100 implementing a display system 102 in a wireless data card 104, according to an embodiment of the present subject matter. The wireless data card 104 is connected to a user device 106 to provide the user device 106 a wireless access to a communication network 108, such as the Internet. For the purpose, the wireless data card 104 is coupled to one or more service providers 110-1, 110-2, 110-3, . . . 110-N via the communication network 108.

In one embodiment of the present subject the display system 102 is integrated to the wireless data card 104, however, in various different embodiments the display system 102 may be a non integral to the wireless data card 104. The display system 102 can be implemented in any of a variety of data cards capable of working with different types of user devices 106. Examples of the user device 106 may include computing systems capable of communicating with a network, such as desktops and laptops, mobile phones, smartphones, and the like. Further, the data cards may include various types of data cards, such as data cards external to the user device 106, data cards internal to the user device 106, data cards utilizing EV-DO technology, data cards utilizing HSDPA technology, and the like. Further, the display system 102 can also be implemented in wireless Universal Serial Bus (USB) adapters and Wi-Fi connectors that may be connected to the user device 106 to enable access to the communication network 108.

The wireless data card 104 is configured to connect to the service providers 110-1, 110-2, 110 either directly through a wireless medium or indirectly through one or more wired or wireless medium to allow access of the communication network 108 to the user device 106. For the purpose of explanation and clarity, the service providers 110-1, 110-2, 110-3, . . . 110-N, are collectively and individually referred to as the service provider(s) 110. Although the service providers 110 are shown to be connected through the communication network 108, it would be appreciated by those skilled in the art that the service providers 110 may be distributed locally or across one or more geographic locations and can be physically or logically connected to each other. Also, the service providers 110 may be implemented on servers, mainframe computers, super computers, and the like. It would be understood by those skilled in the art that the wireless data card 104 may communicate with any one of the service providers 110 at a given time, and may communicate with different service providers at different time instances.

The communication network 108 may be a combination of wired and wireless network. The communication network 108 may be implemented by the service providers through radio frequency coverage in Global System for Mobile communication (GSM) and Code Division Multiple Access (CDMA) standards, or may be implemented by the service providers through the use of routers and access points connected to various Digital Subscriber Line Access Multiplexers (DSLAMs) of wired networks. The communication network 108 can be implemented as one of the different types of networks, such as intranet, telecom network, electrical network, local area network (LAN), wide area network (WAN), Virtual Private Network (VPN), internetwork, Global Area Network (GAN), the Internet, and such. The communication network 108 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one embodiment, the display system 102 implemented in the wireless data card 104, amongst other things, is configured to display the amount of data exchanged between the wireless data card 104 and the service providers 110 on a display of the wireless data card. In one implementation, the display system 102 evaluates the amount of data exchanged based on the data packets sent and received by the wireless data card 104. Further, the display system 102 may also be configured to display the billing information related to the wireless data card 104. The information may be displayed on a display of the wireless data card 104. In one implementation, the display is integrated to the wireless data card 104.

In another implementation, the display system 102 is configured to communicate with the service providers 110 to retrieve the billing information related to the wireless data card 104 such that billing information may be indicated to a user of the user device 106 through the display system 102. Therefore, this eliminates the requirement of a user to perform definite activities, such as logging onto a web portal of the wireless service provider to determine the amount of data exchanged and the billing information in accordance with the data plan availed by the user.

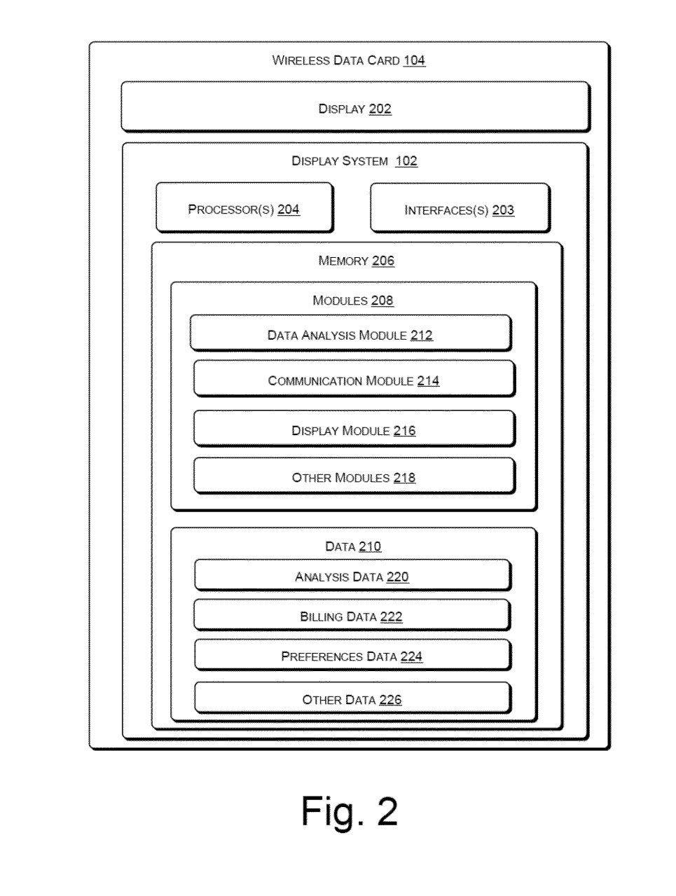

FIG. 2 illustrates exemplary components of the wireless data card 104, according to an embodiment of the present subject matter. In one implementation, the display system 102 may display information related to the data-exchanged between a wireless data card 104 and a service provider 110 (not shown) on a display 202 of the wireless data card 104. The data exchange between the wireless data card 104 and the service provider 110 may take place over a communication network 108 provided by the service provider 110. In said implementation, the data exchanged may include an amount of data packets sent to the service provider 110 by the wireless data card 104 and an amount of data packets received by the wireless data card 104 from the service provider 110. The display system 102 is configured to record the data packets exchanged and determine the total amount of data transfer between the wireless data card 104 and the service provider 110.

The display 202 may be integrated with the wireless data card 104. In one embodiment, the display 202 may include a numeric display, an alphanumeric display, a graphical display, and the like. The display 202 may include any display know in the art, such as a segment display, an electro luminescent display (ELD), a plasma display panel (PDP), an organic light emitting diode (OLED), a light emitting diode (LED) display, a liquid crystal display (LCD), and a thin-film transistor LCD (TFT-LCD).

The display system 102 of the wireless data card 104 includes interface(s) 203, one or more processor(s) 204, and a memory, such as a memory 206, coupled to the processor(s) 204. In one embodiment, the described display system 102 may form an integral part of the wireless data card 104 attached with a display 202. The display system 102 be integrated with the wireless data card 104 and may internally communicate with the wireless data card 104 to exchange information and display the information on the display 202 of the wireless data card 104. In another embodiment, the display system 102 may be external to the wireless data card 104 and may communicate with the wireless data card 104 through various available mode of communications, such as wired connections, communication over wired networks, or communication over wireless networks.

The interfaces 203 may include a variety of software and hardware interfaces, for example, interfaces for peripheral device(s), such as a keypad, user interface screen, and an external display. In one implementation, the interfaces 203 may interface the display system 102 with the display 202 of the wireless data card 104. Further, the interfaces 203 may enable the display system 102 to communicate with users. The interfaces 203 can facilitate multiple communications with the wireless data card 104. The wireless data card 104 may communicate with the service provider 110 within a wide variety of networks and protocol types, including wireless networks such as Wireless LAN (WLAN), cellular, or satellite. In one implementation, the display system 102 may also communicate with the service providers 110. In said implementation, the display system 102 may communicate with the service provider 110 through the wireless data card 104. As explained, the display system 102 may communicate with the wireless data card 104 via the interfaces 202 to communicate with the service provider 110.

The processor(s) 204 may be implemented as one or more microprocessors, microcomputers, microcontrollers, digital signal processors, central processing units, state machines, logic circuitries, and/or any devices that manipulate signals based on operational instructions. Among other capabilities, the processor(s) 204 are configured to fetch and execute computer-readable instructions stored in the memory 206.

The functions of the various elements shown in the figures, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The memory 206 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 includes modules 208 and data 210. The modules 208, amongst other things, include routines, programs, objects, components, data structures, etc., which perform particular tasks or implement particular abstract data types. The data 210 serves, amongst other things, as a repository for storing data processed, received and generated by one or more of the modules 208. The modules 208 further include, for example, a data analysis module 212, a communication module 214, a display module 216, and other module(s) 218. The other modules 218 may include programs that supplement logic and routines on the display system 102. The data 210 includes data generated as a result of the execution of one or more modules 208, such as analysis data 220, billing data 222, preferences data 224 and other data 226. The analysis data may include data analyzed by the data analysis module 212. Further the billing data 222 may store data related to the billing information of the wireless data card 104 generated by the data analysis module 212.

In operation, the data analysis module 212 is configured to keep record of the data exchanged between the wireless data card 104 and the service provider 110. To keep record of the data exchanged, the data analysis module 212 identifies the data packets send by the wireless data card 104, and the data packets received by the wireless data card 104. Each data packet either sent or received by the wireless data card 104 has an associated size. In one implementation, the data analysis module 212 ascertains the size of each packed exchanged between the wireless data card 104 and the service provider 110 to determine the total amount of data exchanged. It would be understood by those skilled in the art that the communication between the wireless data card 104 and the service provider 110 may also exchange some information o establish connection, but for the purpose of determination of data exchanged, the packets exchanged between the user and the service provider 110 would be identified.

In said implementation, the data analysis module 212 is further configured to update the record of data packets in real-time. The data analysis module 212 identifies the data packets exchanged between the wireless data card 104 and the service provider 110 and ascertains the associated size of each packet. It would be understood by those skilled in the art that to determine the amount of total data exchanged in real time, the number of data packets sent and received, and their sizes are to be identified at the time of exchange.

For example, if during the communication between the wireless data card 104 and the service provider 110, the wireless data card 104 sends five data packets of 1.5 Mb each, to identify the data exchanged, the data analysis module 212 may identify the packets before transmission and record the number to be five, and the total size to be 7.5 Mb. Further, in response to the packets sent by the wireless data card 104, the service provider 110 replies with 10 data packets of 2 Mb each, the data analysis module 212 may identify the number and the size of the total data once the data packets are received. It would be understood that in one implementation, to identify the total received data, the size of each data packet is identified one after another in the receiving order of the data packets. However, to identify the total sent data, the total size to be sent may be determined before the actual transmission of the data packets.

The data analysis module 212 is also configured to determine the total amount of data exchanged based on the total sent and received data. In one implementation, the data analysis module 212 combines the amount of data sent and amount of data received to determine the total amount of data exchanged. In the above mentioned example, the data analysis module 212 may identify that the total amount of data exchanged to be 27.5 Mb, and may also identify the total number of data packets exchanged to be 15. In said implementation, the data analysis module 212 may store the information about the data packets received, the data packets sent, the total number of data packets exchanged, and the total amount of data exchanged in the analysis data 220.

According to one embodiment of the present subject matter, the data analysis module 212 is configured to determine the total amount of data exchanged for a particular pre-determined time period. The determination of total amount of data exchanged for each pre-determined period may occur on a cyclic basis. In other words, the determined total amount of data exchanged or the determined total number of data packets exchanged may be refreshed and recorded as fresh information for the new time period based on the pre-determined time period.

In one implementation, the pre-determined time period may be based on the data plan chosen by the user for the wireless data card 104. For example, if the service provider 110 generates the bill for the user for the chosen data plan every month, the data analysis module 212 may access the pre-determined time to be equivalent to one month and determine the total amount of data exchanged between the wireless data card 104 and the service provider 110 on monthly basis. If the pre-determined time period is one month, for the month of January, the data analysis module 212 may determine the total amount of data exchanged. But, to determine the amount of data exchanged for the month of February, the data exchanged during the month of January may be ignored. It would be understood by those skilled in the art that the pre-determined time period may also be of fifteen day, two months, three months, six months or even a complete year. It would also be appreciated that the pre-determined time period may not only be based on the data plan chosen by the user and can be configured by the user himself.

In one implementation, the data plan chosen by a user may be queried from the service provider 110. Therefore, the communication module 214 is configured to interact with the wireless data card 104 through the interface 202 and communicate with the service provider 110 for the purpose of information exchange. In said implementation, the communication module 214 is configured to fetch information related to the data plan chosen by the user. In said implementation, the pre-determined time period may be determined based on the data plan chosen by the user.

In another implementation, the data plan and the associated pre-determined time period may be provided by a user. The user may provide the details through an external keypad via the interface 202. In one embodiment, the user may also provide the details through the user device 106. The details thus provided by the user are utilized by the data analysis module 212 to determine the total amount of data exchanged during each pre-determined time period.

According to an embodiment of the present subject matter, the display module 216 is configured to display the total amount of data exchanged between the wireless data card 104 and the service provider 110 on the display 202 of the wireless data card 104 through the interface 202. The display may include any display know in the art, such as a segment display, Electro Luminescent Display (ELD), Plasma Display Panel (PDP), an Organic Light Emitting Diode (OLED), a Light Emitting Diode (LED) display, a Liquid Crystal Display (LCD), and a Thin Film Transistor LCD (TFT-LCD). It would be understood by those skilled in the art that to drive the display, the display module 216 would include the display drivers associated with the display 202 of the wireless data card 104. The display module 216 may fetch the information about the total amount of data exchanged from the analysis data 220. As described earlier, the information about the total amount of data exchanged between the wireless data card 104 and the service provider 110 is identified and stored in the analysis data 220 by the data analysis module 212.

Further, the display module 216 is also configured to display the information on a display based on user preferences. The user may specify the preference either through a keypad coupled to the display system 102 through the interfaces 202, or may specify the preferences through the user device 106 (not shown). In one implementation, the user preferences are stored in the preferences data 224. In an example, the user may prefer to see the total amount of data exchanged between the wireless data card 104 and the service provider 110. However, in another example, an another user may prefer to display the information about the total amount of data sent by the wireless data card 104 and the total amount of data received by the wireless data card 104 separately. The user may also prefer to display the total number of data packets exchanged or may choose to display the number of packets sent and received separately.

The display module 216 may also display the information according to the user preferences in different formats. For example, to represent the information about the total amount of data exchanged, the display module 216 may represent the amount in number format. In one implementation, the display module 216 may display the information in the format of a graph. In case of representation of information in graph format, the graph may represent the total amount of data exchanged between the wireless data card 104 and the service provider 110 in a progressive manner showing the progressive increase in the total amount of data exchanged over past days. In one example, the display module 216 may also represent the information in the format of an analog dial gauge where the total amount of data exchanged is represented by the show of a needle arm. It would be understood that the display module 216 may represent the information in many formats depending on the user preference.

In one implementation, the display module 216 is configured to refresh the information displayed on the display in real time. As explained earlier, the information of the number of data packets exchanged and the total amount of data exchanged is determined by the data analysis module 212 in real time, and is also stored in the analysis data 220 in real time. Therefore, in said implementation, the display module 216 may fetch the information from the analysis data 220 in real time and display the updated and latest available information on the display 202 of the wireless data card.

The display module 216 is also configured to display a data exchange history. The data exchange history may include the total amount of data exchanged between the wireless data card 104 and the service provider 110 during past periods. The time period for the past data may be based on the pre-determined time. For example, if the pre-determined time period is two months and a user chooses to view the data exchange history in August, the display module 216 may fetch information from the analysis data 220 and display the amount of data exchanged from June to July, March to April, and so on. Similarly, if the pre-determined time period is a year, the data exchange history may show the total amount of data exchanged in previous years.

According to an implementation of the present subject matter, the display system 102 is also configured to provide the billing information to the user. For this purpose, as described earlier, the data plan may be received by the communication module 214 from the service provider 110, or may be provided by the user. As explained earlier, several data plans are provided by the service provider 110 to charge the user according to their data usage. Moreover, such data plans, for example, may limit the amount of data that can be exchanged in a pre-defined time between the wireless data card 104 and the service provider 110.

Further different data plans allow a user to choose from different data transfer limits for the pre-defined time. For example, one data plan may allow a data limit of 1 GB for a period of one month and another data plan may allow a data limit of 5 GB for a period of 2 months. Further, the data plans may also indicate the amount charged by the service provider 110, to a user, for data transfer during the pre-defined time interval. Further, tariffs for data exchange beyond the data transfer limit may also be provided in the data plan and may vary from one plan to the other. For example, an amount of x rupees may be charged from a user for a data plan that allows 1 GB data limit in one month. Similarly, an amount of y rupees may be charged from a user for a data plan that allows 5 GB of data limit in two months. Therefore, it would be appreciated that for different data plans, different amounts may be charged. Further, for the data plan providing 1 GB of data limit in one month may also levy a tariff charge of z paisa/KB when the user exceeds the limit of 1 GB data exchange. The data plan may further specify particular periods as special or happy hours during which the rate of data transfer may be greater than or less than the default data transfer rate.

Therefore, the data plan information received either by the communication module 214, or from the user may be utilized by the data analysis module 212 to evaluate the billing information for the user. Based on the total amount of data exchanged, the data limit restricted by the data plan, and the tariff rates included in the data plan, the data analysis module 212 may evaluate the billing information for the user for the pre-defined time. The evaluated billing information may be stored in the billing data 222 of the memory 206. In one implementation, the billing information present in the billing data 222, evaluated and stored by the data analysis module 212, is displayed on the display 202 of the wireless data card 104 by the display module 216. It would be appreciated that similar to the display of data exchange information, the billing information may be displayed by the display module 216 in different formats, based on the user preferences.

As described earlier, to identify the total amount of data exchange between the user's wireless data card 104, and the service provider 110, conventional techniques of querying the service provider 110 through either web applications or operating system applications may be availed. Therefore, in one implementation, the communication module 214 is configured to receive billing information and the total amount of data exchanged for the wireless data card 104 directly from the service provider 110. Based on the received information, the display module 216 may display the information on the display 202 of the wireless data card. However, it would be understood that the billing and data exchange information received in such a situation may not be updated and therefore, may not represent the actual and true information at any given instance.

Further, the communication module 214 may also retrieve the applicable data transfer rate provided to the user by the service provider 110 at different time instances and provide the information to the display module 216 for display. For example, if during the day time, the data transfer rate provided by the service provider 110 is n MB/sec, and the data transfer rate during night time is m MB/sec, the display module 216 may display the data transfer rate as n MB/sec during the day and m MB/sec during the night.

It would also be understood that during the interaction between the communication module 214 and the service provider 110, the data packets exchanged would be identified by the data analysis module 212 and may contribute in the bill generated for the user. Further, the display module 216 is also configured to generate alert displays to remind a user of access or under usage. In one implementation, if a user crosses the data limit provided by the service provider 110 to the user based on the chosen data plan, the display module 216 may flash an alert signal on the display 202 of the wireless data card 104 to warn the user. Similarly, if the user does not exchange data up to a certain threshold in some fixed amount of time, the display module 216 may flash an alert on the display. It would be appreciated that the flash of an alert may be a red light or an animation displayed on the display 202 of the wireless data card.

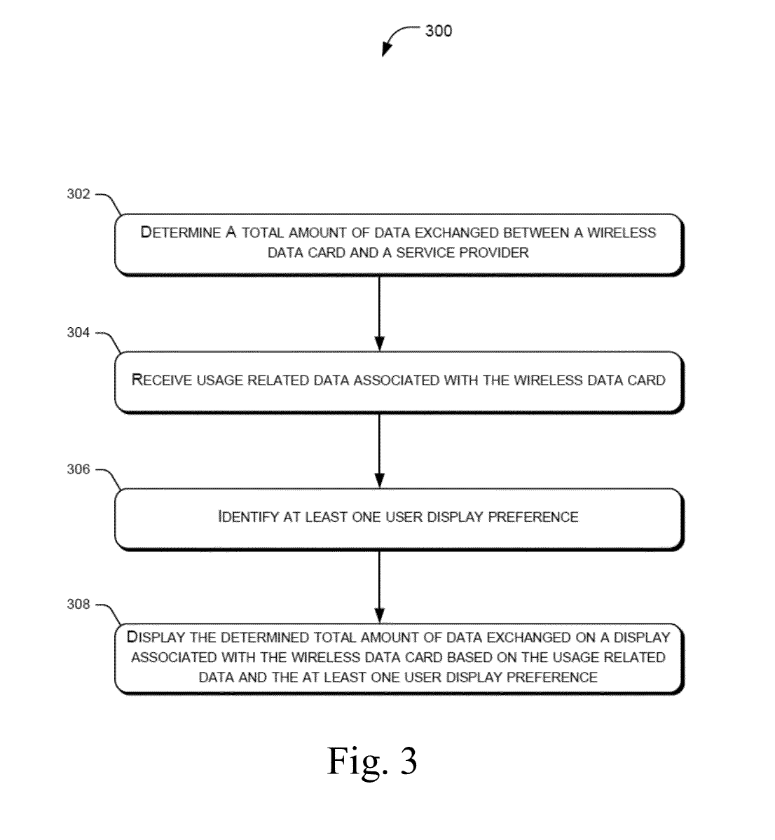

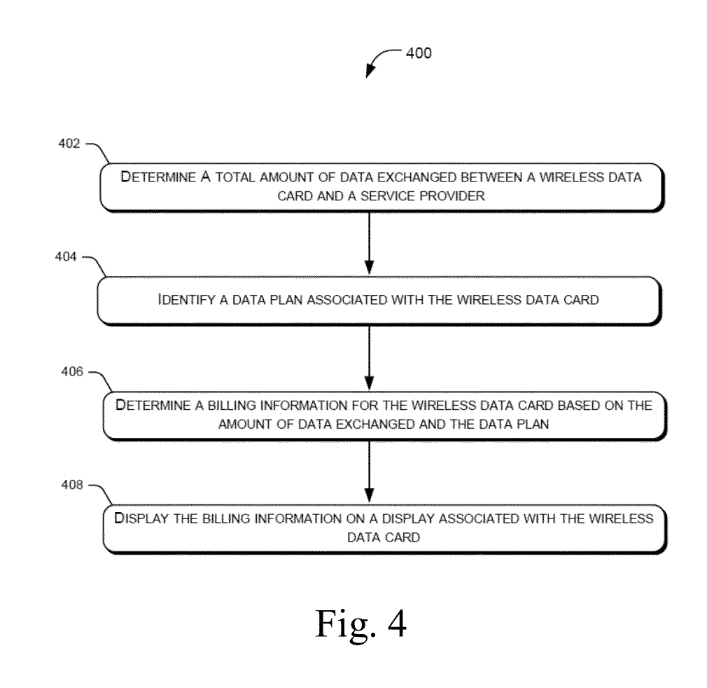

FIGS. 3 and 4 illustrates exemplary methods 300 and 400 for displaying information on a wireless data card, in accordance with an implementation of the present subject matter. FIG. 3 illustrates a method for displaying data exchange information between the wireless data card and the service provider, on a display of the wireless data card while FIG. 4 illustrates a method for displaying billing information on the display of the wireless data card. The method is presently provided for displaying information on a display of a wireless data card. It would be appreciated that the same methods can also be implemented for displaying information on other data cards without deviating from the scope of the present subject matter.

The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the methods can be implemented in any suitable hardware, software, firmware, or combination thereof.

A person skilled in the art will readily recognize that steps of the method can be performed by programmed computers. Herein, some embodiments are also intended to cover program storage devices, for example, digital data storage media, which are machine or computer readable and encode machine-executable or computer-executable programs of instructions, wherein said instructions perform some or all of the steps of the described method. The program storage devices may be, for example, digital memories, magnetic storage media such as a magnetic disks and magnetic tapes, hard drives, or optically readable digital data storage media. The embodiments are also intended to cover both the communication network 108 and user devices 106 configured to perform said steps of the exemplary method.

In FIG. 3, a method for displaying data exchange information between the wireless data card and the service provider, on a display of the wireless data card is illustrated. At block 302, a total amount of data exchanged between a wireless data card and a service provider is determined. In one implementation, the total amount of data exchanged is determined based on the size of data packets sent and received by the wireless data card. The size of each data packet received and the size of each data packet sent by the wireless data card is recorded within the wireless data card to determine the total amount of data exchanged. In said implementation, the total amount of data exchanged is stored in a memory for further use.

In another implementation, the total amount of data exchanged is received from the service provider. The service provider, distributing the connectivity to users generally monitors the amount of data exchanged by each user. Therefore, to identify the total amount of data exchanged by the wireless data card, the service provider may be queried.

At block 304, usage related data of the wireless data card is received. In one implementation, the usage related data may include, but is not limited to, a data plan chosen by a user, a data limit provided by the data plan to the user, a data transfer rate provided by the service provider, and a pre-determined time period based on the data plan. The usage related data in one implementation is received from the service provider. The service provider is queried to provide the details about the data plan, the data limit and the pre-determined time period. In another implementation, the service provider may also provide the tariff related to the usage of data. It would be understood that the tariff applicable may be based on the data plan of the user and may provide the charge to be levied on the user in case of excess usage.

In another implementation, the usage related data may be received from the user. The user may describe the data plan chosen and applicable along with the data limit provided by the data plan. The user may also choose the pre-determined time period. It would also be understood that the pre-determined time period chosen by the user may be based on the data plan, or may be a choice of the user.

At block 306, at least one user display preference is received. In one implementation, the user display preferences may include the choice of display of data exchange information. The user may prefer to view the amount of data received and the amount of data sent by the wireless data card over the view of total amount of data exchanged between the wireless data card and the service provider. Further, the user may also choose the format in which the information is to be displayed. For example, the user may prefer a graph view of the amount of data exchanged over the numeric view of the information.

At block 308, the determined total amount of data exchanged is displayed on a display of the wireless data card based on the usage related data and the at least one user display preference. In one implementation, the display of information also includes the data limit provided by the service provider, and the data transfer rate between the wireless data card and the service provider.

In FIG. 4, a method for displaying billing information on the display of the wireless data card is illustrated. At block 402, a total amount of data exchanged between a wireless data card and a service provider is determined. In one implementation, the total amount of data exchanged is determined based on the size of data packets sent and received by the wireless data card. The size of each data packet received and the size of each data packet sent by the wireless data card is recorded to determine the total amount of data exchanged. In said implementation, the total amount of data exchanged is stored in a memory for further use.

In another implementation, the total amount of data exchanged is received from the service provider. The service provider, distributing the connectivity to users generally monitors the amount of data exchanged by each user. Therefore, to identify the total amount of data exchanged by the wireless data card, the service provider may be queried.

At block 404, a data plan associated with the wireless data card is identified. Generally, a service provider distributes several different data plans for users with different requirements. In one implementation, the data plan chosen by a user is identified. As described earlier, the data plan chosen by the user may include the data transfer limit, the rate of data transfer provided to the user, and the tariff levied on the user in case of excess usage.

At block 406, billing information for the wireless data card, based on the amount of data exchanged and the data plan is determined. In one implementation, information of the total amount of data exchanged between the wireless data card is combined with the tariff applicable as per the data plan to determine the billing information. For example, a data plan chosen by the user may provide a data limit of 100 MB free exchange, and a tariff of 10 paise/KB may also be applicable beyond the data limit usage. In such a scenario, the billing information for a user completing 151 MB of data transfer may be determined based on the excess usage of 1 MB. In the above scenario, the user may be charge with 100 Rupees for the excess usage of 1 MB, as per the tariff plan of the user. In another implementation, the billing information may also include the discounts offered by the service providers and details of the charges during different occasions such as happy hours, festive seasons, etc.

At block 408, the billing information of the user is displayed on a display of the wireless data card. In one implementation, the billing information is displayed according to user preferences. A user may prefer to view the billing information in a particular format. For example, the user may wish to view the billing information of the sent data and received data separately rather than the display of total billing information.

Therefore, the improved method and wireless data card for determining the data exchange and billing information of the wireless data card for a user may provide accurate and real-time information. On one hand, the local determination of information provides the user with real-time update and quick access to the information, on the other, the information directly queried form the service provider allows hassle free and convenient access to the information, without the requirement of user identification login and dedicated application.

Although implementations for displaying information on a display of a wireless data card have been described in language specific to structural features and/or methods, it is to be understood that the appended claims are not necessarily limited to the specific features or methods described. Rather, the specific features and methods are disclosed as exemplary implementations for displaying information on a display of a wireless data card.

1. A wireless data card comprising:
a display;
a processor; and
a memory coupled to the processor, wherein the memory comprises:
a data analysis module configured to determine at least a total amount of data exchanged between the wireless data card and a service provider for a time period; and
a display module configured to present at least the total amount of data exchanged on the display.

2. The wireless data card as claimed in claim 1, wherein the data analysis module is configured to compute the total amount of data exchanged based on the size of data packets sent and received by the wireless data card.

3. The wireless data card as claimed in claim 1, wherein the memory comprises a communication module configured to communicate with the service provider, and receive from the service provider one or more of a usage related data, the total amount of data exchanged, and billing information.

4. The wireless data card as claimed in claim 3, wherein the communication module stores the billing information in the memory, and wherein the communication module is further configured to evaluate monetary charges levied on a user based on the billing information.

5. The wireless data card as claimed in claim 1, wherein the communication module stores preferences data in the memory, the preferences data specifies one or more of a display format of the total amount of data exchanged, a display format of a billing information, the time period, and a usage related data.

6. The wireless data card as claimed in claim 1, wherein the display includes one of a segment display, Electro Luminescent Display (ELD), Plasma Display Panel (PDP), Organic Light Emitting Diode (OLED), Light Emitting Diode (LED) display, Liquid Crystal Display (LCD), and a Thin Film Transistor LCD (TFT-LCD).

7. The wireless data card as claimed in claim 1, wherein the data analysis module is further configured to determine a billing information associated with the wireless data card based on at least one of the total amount of data exchanged and a usage related data.

8. The wireless data card as claimed in claim 7, wherein the display module is further configured to display the billing information on the display.

9. A display system comprising:
a memory, wherein the memory comprises:
a communication module configured to determine at least a total amount of data exchanged between a wireless data card and a service provider for a time period; and
a display module configured to display at least the total amount of data exchanged on a display of the wireless data card.

10. The display system as claimed in claim 9, wherein the display is one or more of a numeric display, an alphanumeric display, and a graphical display.

11. A method for displaying information associated with a wireless data card, the method comprising:
determining at least a total amount of data exchanged between the wireless data card and a service provider for a time period; and
displaying at least the total amount of data exchanged on a display of the wireless data card.

12. The method as claimed in claim 11, wherein the method further comprises:
receiving a data plan associated with the wireless data card;
evaluating a billing information for the wireless data card based on the total amount of data exchanged and the data plan; and
displaying the billing information on the display of the wireless data card.

13. The method as claimed in claim 11, wherein the method further comprises:
receiving usage related data associated with the wireless data card;
identifying at least one user display preference, wherein the total amount of data exchanged is displayed based on the usage related data, and the at least one user preference.

14. The method as claimed in claim 13, wherein the usage related data includes one or more of a data plan associated with the wireless data card, a data limit associated with the wireless data card, and a data transfer rate associated with the data plan.

15. A computer-readable medium storing computer-executable instructions that when executed by a processor cause the processor to perform acts comprising:
determining a total amount of data exchanged between a wireless data card and a service provider;
identifying a data plan associated with the wireless data card;
evaluating a billing information for the wireless data card based on the total amount of data exchanged and the data plan; and
displaying at least one of the billing information and the total amount of data exchanged on a display of the wireless data card.
